(19) United States
(12) Patent Application Publication
(10) Pub. No.: US 2007/0187028 A1
(43) Pub. Date: Aug. 16, 2007

(54) Aqueous adhesion promoting cleaner composition for increasing the adhesion of adhesives and sealants to paints

(76) Inventors: Andreas Braun, Dietikon (CH); Wolf-Rudiger Huck, Zurich (CH)

Correspondence Address: BINGHAM MCCUTCHEN LLP, Three Embarcadero Center, San Francisco, CA, 94111-4067, US

(21) Appl. No.: 11/513,169

(22) Filed: Aug. 31, 2006

(30) Foreign Application Priority Data
Sep. 2, 2005 (EP) 05108067.9

(51) Int. Cl. B32B 37/00

(52) U.S. Cl. 156/281; 510/405

(57) ABSTRACT

The present invention relates to adhesion promoting cleaner compositions which comprise at least one acid having at least one sulphur atom and a pKₐ of less than 2, and also at least one wetting assistant and water. These adhesion promoting cleaner compositions promote the adhesion of adhesives and sealants to paints.

### TECHNICAL FIELD

The present invention pertains to the field of adhesion promoting cleaner compositions.

### PRIOR ART

The use of primers for promoting adhesion of adhesives and sealants has been known for a long time. It has been found that the adhesion of adhesives and sealants to certain substrates is very difficult to bring about.

Painted surfaces are one such substrate which is known to be difficult to bond. Especially critical are the newer generation of automotive paints in combination with one-component polyurethane adhesives.

Efforts have therefore been made to develop pretreatment techniques for increasing the adhesion to paints. Such an increase can be achieved on the one hand by means of physicochemical techniques such as plasma pretreatments. These techniques, however, are costly and inconvenient and necessitate specific apparatus, which severely restricts the use of this pretreatment and makes it more expensive.

EP 1 042 419 B1 describes an undercoat of a solution of a hydrocarbyl-substituted aromatic sulphonic acid in alkyl alcohol, or in an aromatic or alkyl aromatic solvent.

U.S. Pat. No. 4,857,366 describes an undercoat for paints of p-toluenesulphonic acid in a solvent selected from the group comprising ketones, alcohols and aliphatic esters.

The use of solvent, however, is increasingly problematical on environmental, ecotoxicological and occupational-hygiene grounds.

### SUMMARY OF THE INVENTION

It is an object of the present invention, therefore, to provide an adhesion promoting cleaner composition which is free from organic solvents and promotes the adhesion of adhesives or sealants to paints.

Surprisingly it has been found that an aqueous adhesion promoting cleaner composition as claimed solves this problem.

### EMBODIMENTS OF THE INVENTION

The present invention relates to adhesion promoting cleaner compositions which comprise at least one acid having at least one sulphur atom and a pKₐ of less than 2, and also at least one wetting assistant and water.

By “pKₐ” the chemist understands, familiarly, the negative decadic logarithm of the acid dissociation constant Kₐ:pKₐ=−log₁₀Kₐ.

By a wetting assistant is meant, here and below, an organic compound capable of modifying the surface of the water in such a way as to reduce the surface tension of the water and hence to enhance wetting.

The aqueous adhesion promoting cleaner composition comprises at least one acid having at least one sulphur atom and a pKₐ of less than 2.

Such acids are, on the one hand, inorganic acids which are sulphur acids, especially sulphuric acid, sulphurous acids, persulphuric acid, disulphuric (or pyrosulphuric) acid, disulphurous acid, dithionic acid, dithionous acid, thiosulphuric acid or thiosulphurous acid.

Such acids are, on the other hand, organic acids. The acid in question is in this case in particular an organic sulphonic acid. By organic sulphonic acid is meant compounds which have an organic radical containing carbon atoms and also have at least one functional group —SO₃H.

The aromatic sulphonic acid may be monocyclic or polycyclic and there may be one or more sulphonic acid groups present. Possible examples include 1- and 2-naphthalenesulphonic acid, 1,5-naphthalenedisulphonic acid, benzenesulphonic acid and alkylbenzenesulphonic acids.

Preferred aromatic acids are those having the formula (I) 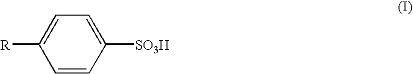
R in this formula is an alkyl radical having 1 to 18 atoms. With preference R is a methyl or dodecyl group, in particular a dodecyl group.

The aqueous adhesion promoting cleaner composition further comprises at least one wetting assistant. Wetting assistants are, on the one hand, surfactants. Surfactants which can be used include natural or synthetic substances which, in solutions, lower the surface tension of the water or of other liquids. Surfactants, also called wetting agents, which can be used include anionic, cationic, nonionic or ampholytic surfactants or mixtures thereof.

Examples of anionic surfactants are surfactants containing carboxylate, sulphate, phosphate or sulphonate groups, such as, for example, amine acid derivatives, fatty alcohol ether sulphates, fatty alcohol sulphates, soaps, alkylphenol ethoxylates, fatty alcohol ethoxylates, and also alkanesulphonates, olefinsulphonates or alkyl phosphates.

The nonionic surfactants include, for example, ethoxylates, such as, for example, ethoxylated adducts of alcohols, such as, for example, polyoxyalkylenepolyols, amines, fatty acids, fatty acid amides, alkylphenols, ethanolamides, fatty amines, polysiloxanes or fatty acid esters, and also alkyl or alkylphenyl polyglycol ethers, such as, for example, fatty alcohol polyglycol ethers, or fatty acid amides, alkylglycosides, sugar esters, sorbitan esters, polysorbates or trialkylamine oxides, and also esters and amides of poly(meth)acrylic acids with polyalkylene glycols, or aminopolyalkylene glycols, which may be capped with alkyl groups but not more than at one end.

Examples of cationic surfactants are quaternary ammonium or phosphonium compounds, such as, for example, tetraalkylammonium salts, N,N-dialkylimidazoline compounds, dimethyldistearylammonium compounds, or N-alkylpyridine compounds, especially ammonium chlorides.

The ampholytic or amphoteric surfactants include amphoteric electrolytes, known as ampholytes, such as, for example, aminocarboxylic acids, and betaines.

Surfactants of this kind are widely available commercially.

Particularly suitable surfactants are nonionic surfactants, especially alkoxylated alcohols, and also cationic surfactants based on ammonium salts. Those which have been found especially suitable include alkoxylated nonionic fluorosurfactants, especially Zonyl® FSO-100, which is available commercially from ABCR, Germany, alkoxylated alcohols or alkoxylated alkylphenols, especially Antrox BL-330, which is available commercially from Rhodia, and organic ammonium salts with alkylbenzyl groups, especially Rhodaquat RP 50, which is available commercially from Rhodia.

The choice of surfactant may depend on the type of preparation. There are certain surfactants which lack long-term stability with the acid and lead on the one hand to visual changes, such as flocs or precipitants, and on the other hand to a change in the wetting and adhesion as well. With these surfactants it is nevertheless entirely possible to produce adhesion promoting cleaner compositions, but it is necessary to ensure that this composition is used immediately after its preparation. For commercial use in such cases, therefore, a two-component pack is advisable, with the acid in one component K1 thereof and the surfactant in the other component K2.

Consequently, in the context of surfactant selection, preference is given to those which together with the acid produce a storage-stable composition, i.e. a composition for which within a storage time of at least 3 months, in particular of more than 6 months, at room temperature, or of at least 1 month at 50° C., no precipitations or turbidities are produced. With surfactants of this kind, one-component compositions are a possibility.

Wetting assistants also include, on the other hand, organic solvents which are miscible with water and are present in the composition in an amount which is at most equal to the amount of the water.

Water-miscible organic solvents of this kind include, in particular, solvents selected from the group comprising methanol, ethanol, propanol, isopropanol, n-butanol, isobutanol, tert-butanol, amyl alcohol; ethylene glycol, propylene glycol, diethylene glycol and polyethylene glycol and also their monoalkyl and dialkyl ethers, glycerol, tetrahydrofuran, dimethyl-formamide, dimethylacetamide, N-methylpyrrolidone, dimethyl sulphoxide, dipropylene glycol and polypropylene glycol and their monoalkyl and dialkyl ethers, or n-butylene or isobutylene glycol, di- and poly(n- or isobutylene glycol) and also their monoalkyl and dialkyl ethers.

The aqueous adhesion promoting cleaner composition further comprises water. The water may be deionized or distilled. Alternatively it is possible to use water which contains dissolved minerals. Care should be taken, however, to ensure that the water does not introduce any contaminants which adversely affect the adhesion. It is therefore preferred for the water to be at least of potable grade.

The aqueous adhesion promoting cleaner composition may comprise further ingredients, including in particular additives, especially stabilizers, emulsifiers, biocides, especially fungicides and/or bactericides, UV stabilizers and heat stabilizers, abrasives, adhesion promoters, especially silanes and/or titanates, pigments and also fluorescent indicators or dyes. Through the use of dyes, for example, it is possible to determine visibly and easily whether a substrate to be bonded or sealed has or has not been treated with the adhesion promoting cleaner composition. In the case of the use of fluorescent indicators, with the assistance of a UV light source, this is also the case. This type of detection is especially advantageous when the substrate surfaces in question are visible. Thus it is possible for the treatment to be detected but to be invisible to the viewer under normal daylight, so that the aesthetic aspect is not negatively impaired.

Further possible ingredients, in addition, are film-forming polymers, which do not react with water, but which are water-soluble or dispersible.

For all of the additional ingredients mentioned it should be ensured that their use in the concentration selected does not deleteriously influence the adhesion of adhesives or sealants and does not adversely affect the stability on storage.

In one preferred embodiment the aqueous adhesion promoting cleaner composition is composed solely of at least one acid having at least one sulphur atom and a PKₐ of less than 2, at least one surfactant and water, and includes no further ingredients; it is particularly preferred for the adhesion promoting cleaner composition to be composed solely of an acid having at least one sulphur atom and a pKₐ of less than 2, a surfactant and water.

The aqueous adhesion promoting cleaner composition has a dynamic viscosity of preferably less than 1000 mpas, in particular less than 100 mPas and more preferably less than 10 mPas.

The acid having at least one sulphur atom and a pKₐ of less than 2 is present in the aqueous adhesion promoting cleaner composition in the form of free acid in a concentration of more than 0.1% by weight, preferably in an amount of 0.1% to 10% by weight, in particular of 0.5% to 10% by weight, based on the weight of the aqueous adhesion promoting cleaner composition.

By the term “in the form of free acid” is meant, here and below, that the acid is in the protonated form and not in the deprotonated form. To the skilled person it is clear, of course, that the amount of the free acid is dependent on the pH of the aqueous composition.

Where the acid having at least one sulphur atom and a PKₐ of less than 2 is an inorganic acid, especially sulphuric acid, the amount of the acid in the form of free acid is advantageously 0.5% to 2% by weight, based on the weight of the aqueous adhesion promoting cleaner composition.

Where the acid having at least one sulphur atom and a pKₐ of less than 2 is an organic acid, especially an organic sulphonic acid, the amount of the acid in the form of free acid is advantageously 1% to 10% by weight, preferably 1% to 5% by weight, based on the weight of the aqueous adhesion promoting cleaner composition.

Furthermore, the fraction of the water is preferably 40% to 99.9% by weight, typically 90% to 99.9% by weight, in particular 95% to 99.5% by weight, based on the weight of the aqueous adhesion promoting cleaner composition.

Where the aqueous adhesion promoting cleaner composition comprises an organic solvent as wetting assistant and/or a film-forming polymer, the fraction of the water is a proportion of the weight of the aqueous adhesion promoting cleaner composition of typically 40%-90% by weight, in particular 50% to 70% by weight, based on the weight of the aqueous adhesion promoting cleaner composition.

The aqueous adhesion promoting cleaner composition is used in particular in the context of paints and varnishes for the purposes of cleaning them and of promoting the adhesion of adhesives and sealants to their surface. By paints are meant, in particular, coatings which are applied to other materials such as, for example, plastics, wood, ceramics, glass, concrete, natural stone, metals or alloys. In particular the substrates in question are painted metals. The paints in question are, in particular, automotive paints, especially automotive paints of the newer generation, in the context of which the adhesives or sealants frequently give cause for adhesion problems. Paints of this kind may for example be those applied by cathodic electrodeposition, or multi-coat paints. A typical automotive paint has at least one basecoat and a topcoat (or clearcoat). The paints used may vary from one model to another and/or within different colours of the same model. The aqueous adhesion promoting cleaner composition of the invention makes it possible to achieve effective adhesion on these problem paints.

As a result of the fact that the aqueous adhesion promoting cleaner composition of the invention does not employ an organic solvent, the great advantage is obtained that it is possible to operate in closed or poorly ventilated spaces without the need for costly and inconvenient air extraction installations or other workplace protection measures. A consequence of this is that use of the aqueous adhesion promoting cleaner composition of the invention results in advantages not only in terms of environment, ecotoxicology and occupational hygiene but also in terms of cost.

The invention additionally provides a method of bonding or sealing. This method is characterized by the fact that it comprises, in one embodiment, the steps of:
a) applying the aqueous adhesion promoting cleaner composition to a substrate S1 to be bonded or sealed
b) applying an adhesive or sealant to the flashed-off aqueous adhesion promoting cleaner composition located on the substrate S1
c) contacting the adhesive or sealant with a second substrate S2.

In another embodiment it comprises the steps of
a′) applying the aqueous adhesion promoting cleaner composition to a substrate S1 to be bonded or sealed
b′) applying an adhesive or sealant to the surface of a second substrate S2, which is composed of the same material as or a different material from the substrate S1
c′) contacting the adhesive or sealant with the flashed-off aqueous adhesion promoting cleaner composition located on the substrate S1.

In yet another embodiment it comprises the steps of
a″) applying the aqueous adhesion promoting cleaner composition to a substrate S1 to be bonded or sealed
b″) flashing off the aqueous adhesion promoting cleaner composition
c″) applying an adhesive or sealant between the surfaces of the substrate Si and S2, the second substrate S2 being composed of the same material as or a different material from the substrate S1.

The second substrate S2 may be composed of the same material as or a material different from the substrate S1. If the second substrate S2 is the same substrate as S1, it is likewise to be cleaned with the aqueous adhesion promoting cleaner composition. If S2 is a substrate different from S1, then it may be necessary, depending on the material and surface of S2, and/or on the adhesive or sealant, to pretreat its surface likewise with the aqueous adhesion promoting cleaner composition and/or with another pretreatment agent, in order to ensure effective adhesion.

It is essential in this context to make sure that, prior to contacting the adhesive or sealant with the surface of the substrate S1 that has been cleaned by means of aqueous adhesion promoting cleaner composition, the said composition has been flashed off—in other words, that the water has very largely undergone evaporation. The time taken for the water to evaporate from the surface is referred to as the flash-off time. The flash-off time is dependent on the one hand on atmospheric humidity, temperature and movements of air over the surface, and on the other hand on the surface structure and the quantity applied. If a surface is blown with hot, dry air, the amount of time taken for the water to evaporate will be substantially less than at cold temperature without blowing. Typically it can be assumed that the waiting time between applying the aqueous adhesion promoting cleaner composition and contacting with the adhesive or sealant will be between 1 minute and 15 minutes, in particular between 1 and 5 minutes.

It is also possible, immediately after the aqueous adhesion promoting cleaner composition has been applied, to wipe it off again with a cloth. In “wipe-off” cases of this kind the open time is essentially 0 minutes and the adhesive or sealant can be applied immediately after wipe-off.

The aqueous adhesion promoting cleaner composition can be applied in a variety of ways. Owing to the advantageously low viscosity of the aqueous adhesion promoting cleaner composition, the preferred application methods are those of spray application and wiping with a soaked cloth.

Application may also be accompanied or followed by rubbing under applied pressure in order to assist the cleaning.

Using the preferred methods, the amount of adhesion promoting cleaner composition applied is just enough for cleaning, and substantial accumulations of acid on the surface are prevented.

After the adhesion promoting cleaner composition has flashed off it is possible for visible streaks or whitish residues or Newton's rings to form on the surface. These residues, though, can easily be removed by simple wiping down or by means of water. For example, when p-toluenesulphonic acid is used as acid, it is common for whitish residues to form, which when viewed under the microscope show crystalline structures. In the case of dodecylbenzylsulphonic acid, streaks are frequently observed, which shimmer in rainbow colours when the incident light is at a slanting angle.

In no case, however, has there been any observation of corrosion to a paint surface or, in the case of painted metals, to the metal beneath the paint coat.

A variety of adhesives or sealants can be used. Depending on the use and service location of the bonded or sealed body, the adhesive or sealant may be epoxy resin-based, isocyanate-based, based on (meth)acrylates or based on silane-terminated polymers (STPs), particularly silane-terminated polyurethanes or silicones. The adhesives or sealants in question may for example be room temperature-curing adhesives or sealants, hotmelt adhesives, dispersion-based adhesives or sealants, or pressure-sensitive adhesives.

The adhesive or sealant may be one-component or multi-component. Preferably the adhesive or sealant is one-component.

With maximum preference the adhesive is a moisture-curing one-component polyurethane adhesive or sealant, in particular a moisture-curing one-component polyurethane adhesive, of the kind available commercially, for example, as Sikaflex® from Sika Schweiz AG.

The joining operation, i.e. step c) or c′), is typically followed by the curing of the adhesive or sealant (step d).

Depending on the particular adhesive or sealant, this step may follow step c) or c′) immediately or with a time lag.

The nature of the bonded or sealed articles thus obtained is diverse. The articles come in particular from the field of industrial manufacture, and are preferably means of transport, especially cars. They may also be components for external mounting. Components of this kind for external mounting are, in particular, prefabricated modular components which are used on the production line as modules and in particular are mounted or installed by adhesive bonding. These prefabricated components for external mounting are preferably used in the construction of means of transport.

Examples of such components for external mounting are the driver's cab of vans or lorries or locomotives, or sliding roofs for cars.

Also possible, however, are applications in the construction of furniture, white goods, such as washing machines, building components such as facings, or lifts.

### EXAMPLES

Compositions with Different Acids

Aqueous compositions were produced by intensive mixing from deionized water, 0.1% by weight of the surfactant Zonyl® FSO-100 from ABCR, Germany, and the specified acid in the concentration specified in Tables 1 and 2 (all acids available commercially from Fluka, Switzerland). All of the solutions were clear with no turbidity.

Experimental Details

These compositions were applied to the paints HDCT and RK described below, using a cellulose cloth (Tela®, Tela-Kimberly Switzerland GmbH) soaked with the composition. After a flash-off time of 10 minutes the one-component moisture-curing polyurethane adhesive Sikaflex®-250 DM-2 or Sikaflex®-250 PCT, which both contain polyurethane prepolymers with isocyanate groups and are available commercially from Sika Schweiz AG, was applied as a circular bead, using a cartridge press and a nozzle, to the adhesion-cleaned paint surface, followed by curing for 7 days at 23° C. and 50% relative humidity (room-temperature climate storage: “KL”), and a third of the bead was tested in the adhesion test described below. Thereafter the sample was placed into water at 23° C. for a further 7 days (water storage: “WL”). After that the adhesion was tested by the bead test for a further third of the bead. After that the specimen was subjected for a further 7 days to a condensation climate of 100% relative humidity and 40° C. (condensation storage: “SW”), after which the adhesion of the final third of the bead was ascertained.

Paints

The two paints referred to below as HDCT and RK, respectively, were obtained from Rocholl GmbH, Germany, and have the following construction

| | HDCT | RK |
|---|---|---|
| Metal | Cold roll steel | Cold roll steel |
| | 04 × 12 × 032″ | 04 × 12 × 032″ |
| E-coat | Cormax 6 Kai | Cormax 6 Kai |
| Primer | HPX 1792 | 1026DG889 |
| Basecoat | DWBH201855 Beige Met. | 545S40606 Silver |
| Clearcoat | HDCT 4041 (PPG) | RK 8046 (DuPont) |

Without adhesion cleaning, these paints have poor adhesion characteristics for one-component polyurethane adhesives.

Adhesion Test (“Bead Test”)

The adhesion of the adhesive was tested by means of the ‘bead test’. In this test an incision is made at the end just above the adhesion face. The incised end of the bead is held with round pliers and pulled from the substrate. This is done by carefully rolling up the bead on the tip of the pliers, and placing a cut vertical to the bead pulling direction down to the bare substrate. The rate of bead removal is chosen so that a cut has to be made approximately every 3 seconds. The test length must amount to at least 8 cm. An assessment is made of the adhesive which remains on the substrate after the bead has been pulled off (cohesive fracture).

The adhesion properties are evaluated by estimation of the cohesive component of the adhesion face:
1=>95% cohesive fracture
2=75-95% cohesive fracture
3=25-75% cohesive fracture
4=<25% cohesive fracture
5=0% cohesive fracture (purely adhesive fracture) “RA” in the evaluation denotes “lateral detachment”, i.e. the fracture pattern shows adhesive fracture at the edges of the bead.

Test results with cohesive fracture values of less than 75% are considered inadequate.

Wetting

Application was carried out using a cellulose cloth (Tela®, Tela-Kimberly Switzerland GmbH) soaked with the aqueous composition to a glass body or to PVC plaques (both from Rocholl GmbH, Germany) which had been wiped down beforehand using isopropanol. The wetting characteristics were assessed as follows:
w: good wetting: homogeneously formed film
p: moderate wetting: after about 1 second: partial rupture of the film

n: poor wetting: isolated drops are formed immediately and run off as beads

TABLE 1
Adhesion of Sikaflex ® 250 DM-2 to paint
“HDCT” cleaned with different aqueous
compositions with 0.1% by weight of Zonyl ®
FSO-100 surfactant (ABCR, Germany).

| | | [% by | | Adhesion | | |
|---|---|---|---|---|---|---|
| | Acid | wt.] | pH | KL | WL | SW |
| Ref. 1 | | 0 | 6 | 5 | 5 | 5 |
| 1 | Dodecylbenzylsulphonic acid | 0.25 | 2 | 5 | 5 | 5 |
| 2 | Dodecylbenzylsulphonic acid | 0.5 | 2 | 5 | 5 | 5 |
| 3 | Dodecylbenzylsulphonic acid | 1 | 1.5 | 1 | 1 | 1 |
| 4 | Dodecylbenzylsulphonic acid | 2.5 | 1 | 1 | 1 | 1 |
| 5 | Dodecylbenzylsulphonic acid | 10 | 0.5 | 2 | 2 | 2 |
| 6 | p-Toluenesulphonic acid | 2.5 | 0.5 | 2 | 2 | 2 |
| Ref. 2 | Sulphuric acid | 0.01 | 2.5 | 5 | 5 | 5 |
| Ref. 3 | Sulphuric acid | 0.1 | 1.7 | 5 | 5 | 5 |
| 7 | Sulphuric acid | 0.5 | 1.2 | 1 | 1 | 1 |
| 8 | Sulphuric acid | 1 | 1 | 1 | 1 | 1 |
| 9 | Sulphuric acid | 2.5 | 0.5 | 5 | 5 | 5 |
| Ref. 4 | Oxalic acid | 2.5 | 0.5 | 5 | 5 | 4 |
| Ref. 5 | Trifluoroacetic acid | 2.5 | 0.5 | 5 | 5 | 5 |
| Ref. 6 | Phosphoric acid | 0.5 | 1.5 | 4 | 4 | 3 |
| Ref. 7 | Phosphoric acid | 2.5 | 1 | 4 | 4 | 3 |
| Ref. 8 | Phosphoric acid | 10 | 0.5 | 4 | 4 | 3 |
| Ref. 9 | Nitric acid | 2.5 | 0 | 4 | 4 | 4 |
| Ref. 10 | Polyphosphoric acid | 2.5 | 1 | 4 | 4 | 4 |
| Ref. 11 | Hydrochloric acid | 0.01 | 2.5 | 5 | 5 | 5 |
| Ref. 12 | Hydrochloric acid | 0.1 | 1.5 | 5 | 5 | 5 |
| Ref. 13 | Hydrochloric acid | 0.5 | 0.5 | 5 | 5 | 5 |
| Ref. 14 | Hydrochloric acid | 1 | 0 | 3 | 3 | 5 |
| Ref. 15 | Hydrochloric acid | 2.5 | 0 | 4 | 4 | 6 |

TABLE 2
Adhesion of Sikaflex ® 250 DM-2 to paint
“RK” cleaned with different aqueous
compositions with 0.1% by weight of Zonyl ®
FSO-100 surfactant (ABCR, Germany).

| | | [% by | | Adhesion | | |
|---|---|---|---|---|---|---|
| | Acid | wt.] | pH | KL | WL | SW |
| Ref. 16 | | 0 | 6 | 4 | 4 | 4 |
| 10 | Dodecylbenzylsulphonic acid | 0.25 | 2 | 2 | 2RA | 2RA |
| 11 | Dodecylbenzylsulphonic acid | 0.5 | 2 | 2 | 2RA | 2RA |
| 12 | Dodecylbenzylsulphonic acid | 1 | 1.5 | 1 | 1 | 1 |
| 13 | Dodecylbenzylsulphonic acid | 2.5 | 1 | 1 | 1 | 1 |
| 14 | Dodecylbenzylsulphonic acid | 10 | 0.5 | 1 | 1 | 1 |
| 15 | p-Toluenesulphonic acid | 2.5 | 0.5 | 1 | 1 | 1 |
| Ref. 17 | Sulphuric acid | 0.01 | 2.5 | 3 | 3 | 3 |
| Ref. 18 | Sulphuric acid | 0.1 | 1.7 | 2 | 3 | 3 |
| 16 | Sulphuric acid | 0.5 | 1.2 | 1 | 2 | 2 |
| 17 | Sulphuric acid | 1 | 1 | 1 | 1 | 1 |
| 18 | Sulphuric acid | 2.5 | 0.5 | 1 | 1 | 1 |
| Ref. 19 | Oxalic acid | 2.5 | 0.5 | 2 | 2 | 2 |
| Ref. 20 | Trifluoroacetic acid | 2.5 | 0.5 | 2 | 2 | 2 |
| Ref. 21 | Phosphoric acid | 0.5 | 1.5 | 2 | 3 | 3 |
| Ref. 22 | Phosphoric acid | 2.5 | 1 | 3 | 3 | 3 |
| Ref. 23 | Phosphoric acid | 10 | 0.5 | 3 | 3 | 3 |
| Ref. 24 | Nitric acid | 2.5 | 0 | 3 | 3 | 3 |
| Ref. 25 | Polyphosphoric acid | 2.5 | 1 | 4 | 4 | 4 |
| Ref. 26 | Hydrochloric acid | 0.01 | 2.5 | 3 | 3 | 3 |
| Ref. 27 | Hydrochloric acid | 0.1 | 1.5 | 2 | 3 | 3 |
| Ref. 28 | Hydrochloric acid | 0.5 | 0.5 | 2 | 3 | 3 |

Compositions with Different Surfactants

Aqueous adhesion promoting cleaner compositions were prepared which are composed of 2.5% by weight of dodecylbenzylsulphonic acid, 0.5% by weight of the surfactant specified in Table 3, and deionized water. Ref.29 is a cleaner composition composed of isopropanol.

TABLE 3
Adhesion of compositions to the “HDCT” paint.

| | | Adhesion | | |
|---|---|---|---|---|
| | Surfactant | KL | WL | SW |
| Ref. 29 | — | 5 | 5 | 5 |
| 19 | Antarox BL-330 (Rhodia) | 1 | 1 | 1 |
| 20 | Zonyl ® FSO-100 (ABCR, Germany) | 1 | 1 | 1 |
| 21 | Hydropalat ® 120 (Cognis) | 1 | 1 | 1 |

Stability of One-Component Compositions with Different Surfactants

Aqueous adhesion promoting cleaner compositions were prepared. The one-component compositions obtained were stored at 50° C. and assessed for wetting and visual changes after 0, 12, 24, 36 and 48 days. The compositions were composed of 2.5% by weight of H₂SO₄, 1% by weight of the surfactant specified in Table 4, and water. Table 5 contains the reference examples, specified in analogy to Table 4, which contain no acid.

TABLE 4
Wetting on glass and PVC after storage of
aqueous compositions comprising surfactant and acid.

| | | After storage at 50° C. for (days): | | | | | | | | | |
|---|---|---|---|---|---|---|---|---|---|---|---|
| | | Wetting on glass | | | | | Wetting on PVC | | | | |
| | | 0 | 12 | 24 | 36 | 48 | 0 | 12 | 24 | 36 | 48 |
| 22 | Rhodaquat RP 50 | w | w | w | w | w | w | w | w | w | w |
| | (from Rhodia, | | | | | | | | | | |
| | Germany) | | | | | | | | | | |
| 23 | Antarox BL-330 | w | w | w | w | w | w | w | w | w | w |
| | (from Rhodia, | | | | | | | | | | |
| | Germany) | | | | | | | | | | |
| 24 | Rhodaclean EFC | w | w | p | — | — | n | n | n | n | n |
| | (from Rhodia, | | | | | | | | | | |
| | Germany) | | | | | | | | | | |
| 25 | Zonyl ®FSO-100 | w | w | w | w | w | w | w | w | w | w |
| | (from ABCR, | | | | | | | | | | |
| | Germany) | | | | | | | | | | |
| 26 | BYK ®-333 | p | w | p | — | — | p | n | n | — | — |
| | (from Byk, | | | | | | | | | | |
| | Germany) | | | | | | | | | | |
| 27 | Hydropalat ® 120 | w | w | w | w | w | w | w | w | w | w |
| | (from Cognis) | | | | | | | | | | |
| 28 | Hydropalat ® 875 | p | w | w | w | p | p | n | p | n | n |
| | (from Cognis) | | | | | | | | | | |

TABLE 5
Wetting on glass and PVC after storage of aqueous
aqueous compositions comprising surfactant without acids.

| | | After storage at 50° C. for (days): | | | | | | | | | |
|---|---|---|---|---|---|---|---|---|---|---|---|
| | | Wetting on glass | | | | | Wetting on PVC | | | | |
| | | 0 | 12 | 24 | 36 | 48 | 0 | 12 | 24 | 36 | 48 |
| Ref. | Rhodaquat RP 50 | w | w | w | w | w | w | w | w | w | w |
| 30 | (from Rhodia, | | | | | | | | | | |
| | Germany) | | | | | | | | | | |
| Ref. | Antarox BL-330 | w | w | w | w | w | w | w | w | w | w |
| 31 | (from Rhodia, | | | | | | | | | | |
| | Germany) | | | | | | | | | | |
| Ref. | Rhodaclean EFC | w | w | w | w | — | w | w | w | w | — |
| 32 | (from Rhodia, | | | | | | | | | | |
| | Germany) | | | | | | | | | | |
| Ref. | Zonyl ®FSO-100 | w | w | w | w | w | w | w | w | w | w |
| 33 | (from ABCR, | | | | | | | | | | |
| | Germany) | | | | | | | | | | |
| Ref. | BYK ®-333 | w | w | w | — | — | p | n | w | — | — |
| 34 | (from Byk, | | | | | | | | | | |
| | Germany) | | | | | | | | | | |
| Ref. | Hydropalat ® | w | w | w | w | w | w | w | w | w | w |
| 35 | 120 (from | | | | | | | | | | |
| | Cognis) | | | | | | | | | | |
| Ref. | Hydropalat ® | w | w | w | w | w | w | w | w | w | w |
| 36 | 875 (from | | | | | | | | | | |
| | Cognis) | | | | | | | | | | |

Tables 6 and 7 list the visual assessments of these compositions 22 to 28, and Ref.30 to Ref.36, respectively. Compositions stored at 50° C. for 48 days were applied to the “HDCT” paint and, after a 10-minute flash-off time, the adhesive Sikaflex®-250 DM-2, as already discussed, was applied, and its adhesion was tested after curing and storage.

TABLE 6
Visual assessment of aqueous compositions
stored at 50° C.

| | | After storage at 50° C. for: | | | | |
|---|---|---|---|---|---|---|
| | | Visual assessment | | | | |
| | | 0 d | 12 d | 24 d | 36 d | 48 d |
| 22 | Rhodaquat RP 50 | clear | clear | clear | clear | clear |
| | (from Rhodia, | | | | | |
| | Germany) | | | | | |
| 23 | Antarox BL-330 | clear | milky | slight | milky | milky |
| | (from Rhodia, | | | sedi- | | |
| | Germany) | | | ment | | |
| 24 | Rhodaclean EFC | clear | turbid | turbid | turbid | — |
| | (from Rhodia, | | | | | |
| | Germany) | | | | | |
| 25 | Zonyl ® FSO-100 | clear | slight | slight | slight | slight |
| | (from ABCR, | | sedi- | sedi- | sedi- | sedi- |
| | Germany) | | ment | ment | ment | ment |
| 26 | BYK ®-333 | clear | white | white | — | — |
| | (from Byk, | | flocs | flocs | | |
| | Germany) | | | | | |
| 27 | Hydropalat ® 120 | clear | milky | clear | clear | milky |
| | (from Cognis) | | | | | |
| 28 | Hydropalat ® 875 | turbid | turbid | turbid | turbid | turbid |
| | (from Cognis) | | | | | |

TABLE 7
Visual assessment of aqueous compositions,
without acids, stored at 50° C.

| | | After storage at 50° C. for: | | | | |
|---|---|---|---|---|---|---|
| | | Visual assessment | | | | |
| | | 0 d | 12 d | 24 d | 36 d | 48 d |
| Ref. | Rhodaquat RP 50 | clear | clear | clear | clear | clear |
| 30 | (from Rhodia, | | | | | |
| | Germany) | | | | | |
| Ref. | Antarox BL-330 | clear | milky | slight | milky | milky |
| 31 | (from Rhodia, | | | sedi- | | |
| | Germany) | | | ment | | |
| Ref. | Rhodaclean EFC | clear | clear | clear | clear | clear |
| 32 | (from Rhodia, | | | | | |
| | Germany) | | | | | |
| Ref. | Zonyl ® FSO-100 | clear | slight | slight | slight | slight |
| 33 | (from ABCR, | | sedi- | sedi- | sedi- | sedi- |
| | Germany) | | ment | ment | ment | ment |
| Ref. | BYK ®-333 | clear | clear | clear | — | — |
| 34 | (from Byk, Germany) | | | | | |
| Ref. | Hydropalat ® 120 | clear | milky | clear | clear | milky |
| 35 | (from Cognis) | | | | | |
| Ref. | Hydropalat ® 875 | clear | clear | clear | clear | clear |
| 36 | (from Cognis) | | | | | |

TABLE 8
Adhesion of adhesive to paints to which stored aqueous
compositions were applied.

| | | Adhesion | | |
|---|---|---|---|---|
| | Surfactant | KL | WL | SW |
| 22 | Rhodaquat RP 50 (from Rhodia, Germany) | 2 | 1 | 1 |
| 23 | Antarox BL-330 (from Rhodia, Germany) | 2 | 1 | 1 |
| 25 | Zonyl ® FSO-100 (from ABCR, Germany) | 3 | 4 | 4 |
| 27 | Hydropalat ® 120 (from Cognis) | 3 | 3 | 3 |
| 28 | Hydropalat ® 875 (from Cognis) | 3 | 2 | 2 |

1. Aqueous adhesion promoting cleaner composition comprising
at least one acid having at least one sulphur atom and a pKₐ<2;
water;
at least one wetting assistant;
the concentration of the acid amounting to more than 0.1% by weight, based on the weight of the aqueous adhesion promoting cleaner composition.

2. Aqueous adhesion promoting cleaner composition according to claim 1, characterized in that the wetting assistant comprises a surfactant.

3. Aqueous adhesion promoting cleaner composition according to claim 2, characterized in that the surfactant is an alkoxylated nonionic fluorosurfactant, an alkoxylated alcohol, an alkoxylated alkylphenol or an organic ammonium salt having alkylbenzyl groups.

4. Aqueous adhesion promoting cleaner composition according to claim 1, characterized in that the wetting assistant is an organic, water-miscible solvent and is present in the composition in an amount which is at most equal to the amount of the water.

5. Aqueous adhesion promoting cleaner composition according to claim 4, characterized in that the organic, water-miscible solvent is selected from the group comprising methanol, ethanol, propanol, isopropanol, n-butanol, isobutanol, tert-butanol, amyl alcohol; ethylene glycol, propylene glycol, diethylene glycol and polyethylene glycol and also their monoalkyl and dialkyl ethers, glycerol, tetrahydrofuran, dimethylformamide, dimethylacetamide, N-methylpyrrolidone, dimethyl sulphoxide, dipropylene glycol and polypropylene glycol and their monoalkyl and dialkyl ethers, and butanediol.

6. Aqueous adhesion promoting cleaner composition according to claim 1, characterized in that the at least one acid having at least one sulphur atom and a pKₐ<2 is sulphuric acid.

7. Aqueous adhesion promoting cleaner composition according to claim 1, characterized in that the at least one acid having at least one sulphur atom and a pKₐ<2 is an organic sulphonic acid, in particular an aromatic sulphonic acid.

8. Aqueous adhesion promoting cleaner composition according to claim 7, characterized in that the acid is an acid of the formula (I) 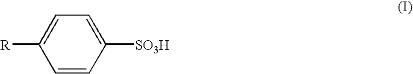
where R is an alkyl radical having 1 to 18 atoms, in particular a methyl or dodecyl group, preferably a dodecyl group.

9. Aqueous adhesion promoting cleaner composition according to claim 1, characterized in that the acid is in the form of free acid in an amount of 0.1% to 10% by weight, based on the weight of the aqueous adhesion promoting cleaner composition.

10. Aqueous adhesion promoting cleaner composition according to claim 9, characterized in that the acid is sulphuric acid and the amount of the acid in the form of free acid is 0.5% to 2% by weight, based on the weight of the aqueous adhesion promoting cleaner composition.

11. Aqueous adhesion promoting cleaner composition according to claim 9, characterized in that the acid is an organic sulphonic acid and the amount of the acid in the form of free acid is 1% to 10% by weight, based on the weight of the aqueous adhesion promoting cleaner composition.

12. Aqueous adhesion promoting cleaner composition according to claim 1, characterized in that the fraction of the water is 40% to 99.9% by weight, typically 90% to 99.9% by weight, in particular 95% to 99.5% by weight, based on the weight of the aqueous adhesion promoting cleaner composition.

13. Use of an aqueous adhesion promoting cleaner composition according to claim 1 for promoting the adhesion of adhesives or sealants to painted surfaces.

14. Method of bonding or sealing, comprising the steps of
a) applying an aqueous adhesion promoting cleaner composition according to claim 1 to a substrate S1 to be bonded or sealed
b) applying adhesive or sealant to the flashed-off aqueous adhesion promoting cleaner composition located on the substrate S1
c) contacting the adhesive or sealant with a second substrate S2;
or
a′) applying an aqueous adhesion promoting cleaner composition according to claim 1 to a substrate S1 to be bonded or sealed
b′) applying adhesive or sealant to the surface of a second substrate S2, which is composed of the same material as or a different material from the substrate S1
c′) contacting the adhesive or sealant with the flashed-off aqueous adhesion promoting cleaner composition located on the substrate S1;
or
a″) applying an aqueous adhesion promoting cleaner composition according to claim 1 to a substrate S1 to be bonded or sealed
b″) flashing off the aqueous adhesion promoting cleaner composition
c″) applying an adhesive or sealant between the surfaces of the substrate S1 and S2,
the second substrate S2 being composed of the same material as or a different material from the substrate S1.

15. Method according to claim 14, characterized in that step c) or c′) or c″) is followed by a step d) of curing the adhesive or sealant.

16. Method according to claim 14, characterized in that the adhesive is a moisture-curing one-component polyurethane adhesive.

17. Method according to claim 14, characterized in that the substrate S1 is a paint, in particular a painted metal.

18. Bonded or sealed article obtained by a method according to claim 14.

19. Bonded or sealed article according to claim 18, characterized in that the article is a means of transport, in particular a car, or a component for external mounting on a means of transport, in particular a car.
